(19) United States
(12) Patent Application Publication
(10) Pub. No.: US 2026/0012868 A1
(43) Pub. Date: Jan. 8, 2026

(54) SYSTEM AND METHOD FOR EPS FALLBACK

(71) Applicant: JIO PLATFORMS LIMITED, Ahmedabad, Gujarat (IN)

(72) Inventors: Brijesh SHAH, Navi Mumbai, Maharashtra (IN); Yashesh BUCH, Navi Mumbai, Maharashtra (IN); Sourabh BAJPAI, Mumbai, Maharashtra (IN); Mayank TARAN, Distt Thane, Maharashtra (IN); Nitesh CHOURASIA, Mumbai, Maharashtra (IN); Kapil B GUPTA, Navi Mumbai, Maharashtra (IN); Potti VASUDHA, Bangalore, Karnataka (IN); Srinivasa Rao VUNDAVILLI, Bangalore, Karnataka (IN); Aayush BHATNAGAR, Navi Mumbai, Maharashtra (IN); Pradeep Kumar BHATNAGAR, Navi Mumbai, Maharashtra (IN)

(73) Assignee: JIO PLATFORMS LIMITED, Ahmedabad, Gujarat (IN)

(21) Appl. No.: 18/992,633

(22) PCT Filed: May 7, 2024
(86) PCT No.: PCT/IN2024/050497

§ 371 Date: Jan. 9, 2025

(30) Foreign Application Priority Data
May 31, 2023 (IN) 202321037691

(51) Int. Cl. H04W 36/14; H04L 43/0829

(52) U.S. Cl. CPC H04W 36/14; H04L 43/0829

(57) ABSTRACT

The present disclosure relates to a method for performing an evolved packet system fallback (EPSFB). The present disclosure automatically allows a user to make voice call on a Long-Term Evolution (LTE) network when a user equipment (UE) (104, 310, 410) is not capable to make voice call on a 5G standalone (SA) network via redirection or via handover. The present disclosure allows the user to release the 5G SA network and redirect to measured evolved universal terrestrial radio access (E-UTRA) absolute radio frequency channel number (EARFCN) of LTE band to proceed an evolved packet system fallback (EPSFB) call successfully, if there is unprecedented failure during the handover procedure. The present disclosure allows the user to get redirected on reported frequency with best measurement when handover failed.

### RESERVATION OF RIGHTS

A portion of the disclosure of this patent document contains material

which is subject to intellectual property rights such as, but are not limited to, copyright, design, trademark, integrated circuit (IC) layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The present disclosure relates to a field of 5G standalone (SA) cellular technology, and specifically to a system and a method for Evolved Packet System Fallback (EPSFB).

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

In general, voice over New Radio (NR) with Evolved Packet System Fallback (EPSFB) may be defined as a mobility procedure where a network triggers the procedure for a User Equipment (UE) to change Radio Access from 5G to 4G. EPSFB may enable phones to use a 5G Core (5GC) with NR, but a Radio Access Network (RAN) may trigger moving the phone Long Term Evolution (LTE) connected to an Evolved Packet Core (EPC) during call establishment. EPSFB call although initiates on NR but eventually falls back to an LTE layer and succeeds over an EPC core network that is also connected to an Internet Protocol (IP) Multimedia Subsystem (IMS), effectively making it Voice over Long-Term Evolution (VoLTE) call after the fallback.

Conventionally, a gNodeB (also referred to as gNB) may configure the UE for B1 measurements and set a wait timer to receive a B1 measurement report, after getting a Packet Data Unit (PDU) session modification request from an Access & Mobility Management Function (AMF) for Quality of Service (QoS) flow of IMS voice. Due to some uncertainty if the UE fails to send the B1 measurement before the wait timer expiry, EPSFB procedure via Inter Radio Access Technology (IRAT) Handover fails and the UE is not able to make voice call on system. This issue may also be observed when the EPSFB procedure via release with redirection to reported frequency is enabled. gNB may be waiting for the B1 measurement report from UE to take decision of release with redirection.

After getting the B1 measurement report from the UE, the gNB may initiate IRAT handover, but when the UE sends the B1 measurement report for LTE cell, which is not available in the NR to LTE neighbour list, EPSFB procedure fails, and the UE is not able to make voice call on system. When the gNB initiates IRAT handover procedure after receiving the B1 measurement report from the UE for valid LTE neighbour already available in NR to LTE neighbour list and handover fails in either preparation phase or in execution phase, the EPSFB procedure fails, and the UE is not able to make voice call on system and user faces the bad experience.

Further, EPS Fallback may not be triggered by an Outdoor Small Cell (ODSC) when it receives an A3 event Measurement Report (MR) for Intra-FA handover to the neighbour cell while it is waiting for B1 MR to start EPSFB. EPSFB may not be triggered, when the UE already sent the A3 event measurement, the gNB is preparing for Intra-FA handover, and the PDU session modification request is received from the AMF for QOS flow of IMS voice.

There is, therefore, a need in the art to improve state of automatically allowing the user to make Voice call on LTE network when the UE is not capable to make Voice call on the 5G SA network via redirection or via Handover.

### DEFINITION

As used in the present disclosure, the following terms are generally intended to have the meaning as set forth below, except to the extent that the context in which they are used to indicate otherwise.

The term PCI as used herein, refers to physical cell identifier (ID). The PCI is used to indicate the physical layer identity of the cell. The PCI is used for cell identity during cell selection procedure. The purpose of PCI optimization is to ensure to a great extent that neighboring cells should have different primary sequences allocated.

The term B1 MR as used herein, refers to B1 measurement report. B1 is a measurement of the signal quality within a long-term evolution (LTE) system. B1 is measured at the eNodeB (eNB) and indicates the signal quality that an user equipment (UE) would receive from a femtocell if it were connected to that femtocell.

The term IRAT HO as used herein, refers to inter radio access technology handover. IRAT is mainly used for handover between different RAT. The UE while in one RAT performs neighbour cell measurements and sends measurement report to the network. Based on this measurement report provided by mobile terminal, network can initiate handover from one RAT to the other RAT.

The term NRT as used herein, refers to a neighbour relation table. The NRT is a table that is used by network devices to maintain information about their direct neighbors. The NRT contains information about the devices that are connected to the same network segment as the local device.

The term EPSFB as used herein, refers to evolved packet system fallback. The EPSFB call is coordinated between a 5G system and evolved packet system (EPS) and transition of the call happens from 5G NR to the legacy LTE network after the negotiation of both UE and network capabilities,

The term E-UTRA as used herein, refers to evolved UMTS terrestrial radio access. The E-UTRA is the air interface of 3rd generation partnership project (3GPP) long term evolution (LTE) upgrade path for mobile networks.

The term EARFCN as used herein, refers to evolved universal terrestrial radio access (E-UTRA) absolute radio frequency channel number (EARFCN). In LTE, the carrier frequency in the uplink and downlink is designated by EARFCN. The EARFCN uniquely identify the LTE band and carrier frequency.

### OBJECTS OF THE PRESENT DISCLOSURE

It is an object of the present disclosure to automatically allow a user to make Voice call on a Long-Term Evolution (LTE) network when a User Equipment (UE) is not capable to make voice call on a 5G Standalone (SA) network via redirection or via Handover.

It is an object of the present disclosure to allow the user to release the 5G SA network and redirect to measured Evolved Universal Terrestrial Radio Access (E-UTRA) Absolute Radio Frequency Channel Number (EARFCN) of LTE band to proceed an Evolved Packet System Fallback (EPSFB) call successfully, if there is unprecedented failure during the handover procedure.

It is an object of the present disclosure to allow the user to get redirected on reported frequency with best measurement when handover fails.

It is an object of the present disclosure to improvise the network capabilities.

It is an object of the present disclosure to enhance the user experience.

It is an object of the present disclosure to provide seamless network services to users.

It is an object of the present discourse to cater all sorts of voice calls.

It is an object of the present disclosure to dynamically manage the communication channels.

### SUMMARY

In an exemplary embodiment, the present invention discloses a method for performing an evolved packet system fallback (EPSFB). The method comprising receiving at least one packet data unit (PDU) session modification request related to at least one voice call for at least one user equipment (UE) connected to a source node of a first network. The method comprising configuring the at least one UE with at least one event measurement by the source node. The method comprising receiving at least one measurement report (MR) related to the at least one event measurement from the at least one UE. The at least one MR includes at least one first physical cell identifier (PCI) associated with at least one target node of a second network. The method comprising receiving at least one neighbour relation table (NRT) associated with the at least one UE. The at least one NRT includes at least one second PCI associated with at least one UE reported neighbour cell. The method comprising determining if the first PCI matches with the second PCI. The method comprising redirecting the at least one UE to release a connection with the source node of the first network and reselect at least one UE reported frequency band of the second network when the at least one first PCI do not match with the at least one second PCI. The method comprising initiating a handover procedure when the at least one first PCI matches with the at least one second PCI. The method comprising redirecting the at least one UE to release the connection with the source node of the first network and reselect the at least one UE reported frequency band of the second network when the handover procedure fails.

In some embodiments, the at least one UE is registered with at least one radio resource control (RRC) active mode with a downlink (DL) data session and an uplink (UL) data session.

In some embodiments, the at least one measurement report (MR) is received within an expiry of at least one timer.

In some embodiments, the at least one UE reported frequency band is associated with the at least one UE reported neighbour cell.

In some embodiments, the PDU session modification request is received from an access and mobility management function (AMF) associated with the first network.

In some embodiments, the handover procedure fails due to an issue generated during a preparation phase or an execution phase of the EPSFB. In some embodiments, the at least one MR related to the at least one event measurement received from the at least one UE is a B1 measurement report. In some embodiments, the initiated handover procedure is an inter radio access technology (IRAT) handover procedure.

In some embodiments, the method further comprising redirecting the at least one UE to release a connection with the source node of the first network and reselect at least one UE reported frequency band of the second network when the B1 measurement report is not received within the expiry of at least one timer.

In some embodiments, the method further comprising redirecting the at least one UE to release a connection with the source node of the first network and reselect at least one UE reported frequency band of the second network when the at least one UE is active with at least one other procedure of the first network.

In some embodiments, the method further comprising redirecting the at least one UE to release a connection with the source node of the first network and reselect at least one UE reported frequency band of the second network when the at least one UE is stuck in at least one race condition generated in the first network.

In some embodiments, the EPSFB is triggered through a handover procedure or a redirection procedure depending upon a plurality of radio frequency (RF) conditions of the at least one UE.

In some embodiments, the plurality of radio frequency (RF) conditions of the at least one UE depends on a geographical area where the at least one UE is located.

In some embodiments, the EPSFB is triggered through a handover procedure or a redirection procedure depending upon the at least one race condition generated in the first network.

In some embodiments, the reported frequency band is configured by a gNodeB during an emergency voice call made by the at least one UE. In some embodiments, the first network is a 5G network and the second network is a 4G network.

In an exemplary embodiment, the present invention discloses a system for performing an evolved packet system fallback (EPSFB). The system is configured to receive at least one packet data unit (PDU) session modification request related to at least one voice call for at least one user equipment (UE) connected to a source node of a first network. The system is configured to configure the at least one UE with at least one event measurement by the source node. The system is configured to receive at least one measurement report (MR) related to the at least one event measurement from the at least one UE. The at least one MR includes at least one first physical cell identifier (PCI) associated with at least one target node of a second network. The system is configured to receive at least one neighbour relation table (NRT) associated with the at least one UE. The at least one NRT includes at least one second PCI associated with at least one UE reported neighbour cell. The system is configured to determine if the first PCI matches with the second PCI. The system is configured to redirect the at least one UE to release a connection with the source node of the first network and reselect at least one UE reported frequency band of the second network when the at least one first PCI do not match with the at least one second PCI. The system is configured to initiate a handover procedure when the at least one first PCI matches with the at least one second PCI. The system is configured to redirect the at least one UE to release the connection with the source node of the first network and reselect the at least one UE reported frequency band of the second network when the at least one handover procedure fails.

In some embodiments, the at least one UE is registered with at least one radio resource control (RRC) active mode with a downlink (DL) data session and an uplink (UL) data session.

In some embodiments, the at least one measurement report (MR) is received within an expiry of at least one timer.

In some embodiments, the at least one UE reported frequency band is associated with the at least one UE reported neighbour cell.

In some embodiments, the PDU session modification request is received from an access and mobility management function (AMF) associated with the first network.

In some embodiments, the handover procedure fails due to an issue generated during a preparation phase or an execution phase of the EPSFB.

In some embodiments, the at least one MR related to the at least one event measurement received from the at least one UE is a B1 measurement report.

In some embodiments, the initiated handover procedure is an inter radio access technology (IRAT) handover procedure.

In some embodiments, the system is further configured to redirect the at least one UE to release a connection with the source node of the first network and reselect at least one UE reported frequency band of the second network when the B1 measurement report is not received within the expiry of at least one timer.

In some embodiments, the system is further configured to redirect the at least one UE to release a connection with the source node of the first network and reselect at least one UE reported frequency band of the second network when the at least one UE is active with at least one other procedure of the first network.

In some embodiments, the system is further configured to redirect the at least one UE to release a connection with the source node of the first network and reselect at least one UE reported frequency band of the second network when the at least one UE is stuck in at least one race condition generated in the first network.

In some embodiments, the EPSFB is triggered through a handover procedure or a redirection procedure depending upon a plurality of radio frequency (RF) conditions of the at least one UE.

In some embodiments, the plurality of radio frequency (RF) conditions of the at least one UE depends on a geographical area where the at least one UE is located.

In some embodiments, the EPSFB is triggered through a handover procedure or a redirection procedure depending upon the at least one race condition generated in the first network.

In some embodiments, the reported frequency band is configured by a gNodeB during an emergency voice call made by the at least one UE. In some embodiments, the first network is a 5G network and the second network is a 4G network.

In an exemplary embodiment, the present invention discloses a network comprising at least one network element for performing an evolved packet system fallback (EPSFB) release with redirection on at least one reported frequency. The at least one network element is configured to receive at least one packet data unit (PDU) session modification request related to at least one voice call for at least one user equipment (UE) connected to a source node of a first network. The at least one network element is configured to configure the at least one UE with at least one event measurement by the source node. The at least one network element is configured to receive at least one measurement report (MR) related to the at least one event measurement from the at least one UE. The at least one MR includes at least one first physical cell identifier (PCI) associated with at least one target node of a second network. The at least one network element is configured to receive at least one neighbour relation table (NRT) associated with the at least one UE. The at least one NRT includes at least one second PCI associated with at least one UE reported neighbour cell. The at least one network element is configured to determine if the first PCI matches with the second PCI. The at least one network element is configured to redirect the at least one UE to release a connection with the source node of the first network and reselect at least one UE reported frequency band of the second network when the at least one first PCI do not match with the at least one second PCI. The at least one network element is configured to initiate a handover procedure when the at least one first PCI matches with the at least one second PCI. The at least one network element is configured to redirect the at least one UE to release the connection with the source node of the first network and reselect the at least one UE reported frequency band of the second network when the at least one handover procedure fails.

In an exemplary embodiment, the present invention discloses a user equipment (UE) communicatively coupled with a network. The coupling comprises steps of receiving, by the network, a connection request, sending an acknowledgment of the connection request to the UE and transmitting a plurality of signals in response to the connection request. The network comprising one or more network elements configured to receive at least one packet data unit (PDU) session modification request related to at least one voice call for the UE. The one or more network elements is configured to configure the UE with at least one event measurement. Receive at least one measurement report (MR) related to the at least one event measurement from the UE. The at least one MR includes at least one first physical cell identifier (PCI) associated with at least one target node of another network. Receive at least one neighbour relation table (NRT) associated with the UE. The at least one NRT includes at least one second PCI associated with the UE reported neighbour cell. Determine if the first PCI matches with the second PCI. Redirect the UE to release a connection with the network and reselect the UE reported frequency band of another network when the at least one first PCI do not match with the at least one second PCI. Initiate a handover procedure when the at least one first PCI matches with the at least one second PCI. Redirect the UE to release the connection with the network and reselect the UE reported frequency band of another network when the handover procedure fails.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

The diagrams are for illustration only, which thus is not a limitation of the present disclosure, and wherein:

FIG. 1 illustrates an exemplary network architecture (100) in which or with which embodiments of the present disclosure may be implemented.

FIG. 2 illustrates an exemplary block diagram (200) of an Evolved Packet System Fallback (EPSFB) release system, in accordance with an embodiment of the present disclosure.

FIG. 3 illustrates an exemplary flow mechanism (300) of 5G to 4G Inter-Radio Access Technology (RAT) handover, in accordance with an embodiment of the present disclosure.

FIG. 4 illustrates an exemplary flow mechanism (400) for performing 5G to 4G release with redirection, in accordance with an embodiment of the present disclosure.

FIG. 5 illustrates an exemplary flow diagram (500) for performing EPSFB release with redirection on reported frequency, in accordance with an embodiment of the present disclosure.

FIG. 6 illustrates an exemplary computer system (600) in which or with which embodiments of the present disclosure may be implemented.

FIG. 7 illustrates an exemplary flow diagram for a method for performing an evolved packet system fallback (EPSFB), in accordance with an embodiment of the present disclosure.

### LIST OF REFERENCE NUMERALS

100—Network architecture
102—A plurality of users
104, 310, 410—A plurality of user equipments (UEs)
106—Network
108—Evolved packet system fallback (EPSFB) release system
200—Block Diagram
202—A plurality of processor(s)
204—Memory
206—A plurality of interface(s)
208—Processing engine
210—Configuration engine
212—Redirection engine
214—Database
300—Flow diagram
320, 420—gNodeB
330, 430—Access and mobility management function (AMF)
340, 440—Mobile management entity (MME)
350, 450—eNodeB
400—Flow diagram
500—Flow diagram
600—A computer system
610—External storage device
620—Bus
630—Main memory
640—Read only memory
650—Mass storage device
660—Communication port(s)
670—Processor
700—Flow diagram

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Generally, Voice over New Radio (NR) with Evolved Packet System Fallback (EPSFB) may be defined as a mobility procedure where a network triggers the procedure for a User Equipment (UE) to change Radio Access from 5G to 4G. EPSFB may enable phones to use a 5G Core (5GC) with NR, but a Radio Access

Network (RAN) may trigger moving the phone Long Term Evolution (LTE) connected to an Evolved Packet Core (EPC) during call establishment. EPSFB call although initiates on NR but eventually falls back to an LTE layer and succeeds over an EPC core network that is also connected to an Internet Protocol Multimedia Subsystem (IMS), effectively making it Voice over Long-Term Evolution (VOLTE) call after the fallback.

EPSFB call may be coordinated between a 5G System (5GS), and an Evolved Packet System (EPS) systems and transition of the call happens from 5G NR to a legacy LTE network after the negotiation of both UE and network capabilities. At the stage of UE registration, the 5GS and UE capabilities are negotiated during the initial registration process to conclude if EPSFB or Voice over New Radio (VoNR) may be utilized.

To maintain the voice service in Next-Generation Radio Access Network (NG-RAN), the UE provides additional capabilities over a Radio Resource Control (RRC) layer that may be used to determine accurate NR voice support options. In UE capability information message in NR RRC layer, UE may convey capabilities related to the IMS. After voice over IMS is determined, the UE may start IMS registration and then may make VoNR (or EPSFB) calls.

At the call initiation, if a request for establishing the QoS flow for IMS voice reaches the NG-RAN, NG-RAN may be configured to support EPS fallback for IMS voice and decides to trigger fallback to EPS, taking into account UE capabilities, indication from Access and Mobility Management Function (AMF) that “Redirection for EPS fallback for voice is possible,” network configuration (e.g. N26 availability configuration) and radio conditions, then the redirection or handover procedure to LTE starts. After the UE camps successfully on the LTE cell and initiates Tracking Area Update procedure (TAU) or a fresh attach process (in case of TAU failure or no support for N26), the call continues normally as VoLTE call.

The proposed disclosure enhances user experience by increasing the successful attempts of transition from 5G to 4G for UE which are not capable of VoNR. The proposed disclosure also reduces the delay in transition from 5G to 4G to make a successful voice call. The EPSFB method improves the EPSFB success rate by allowing the user or the UE to take proactive decision to move on to other Radio Access Technology (RAT) when the UE is not capable to make voice call on a 5G Standalone (SA) RAT. The EPSFB method may help the UE to avoid various race condition generated in the system and blocking the UE to select 4G RAT to make voice call. The method may also help the user and the UE to reduce a transition time from 4G to 5G via Inter Radio Access Technology (IRAT) Handover during the EPSFB. The method may trigger the EPSFB via Handover or via Redirection depending upon the situation and Radio Frequency (RF) conditions on a geography where the UE is located.

The 5G to 4G release with redirection may refer to 5G radio connection release with the 5G radio resource control (RRC) release instructing a UE to reselect to a 4G cell where a new radio connection can be started for the Voice over LTE (VoLTE) call. In this case, the UE context is transferred from the an access and mobility management function (AMF) to a mobility management entity (MME) over a N26 interface. Further, measurement based redirection may refer to the UE measuring target LTE carriers in order to provide the gNB the best one. The UE receives a release from NR network and reconnects on LTE network on the carrier indicated in the release.

The method may allow the gNB to take quick decision of EPSFB Handover based or redirection based, depending on the RF condition of UE, and race condition of the system.

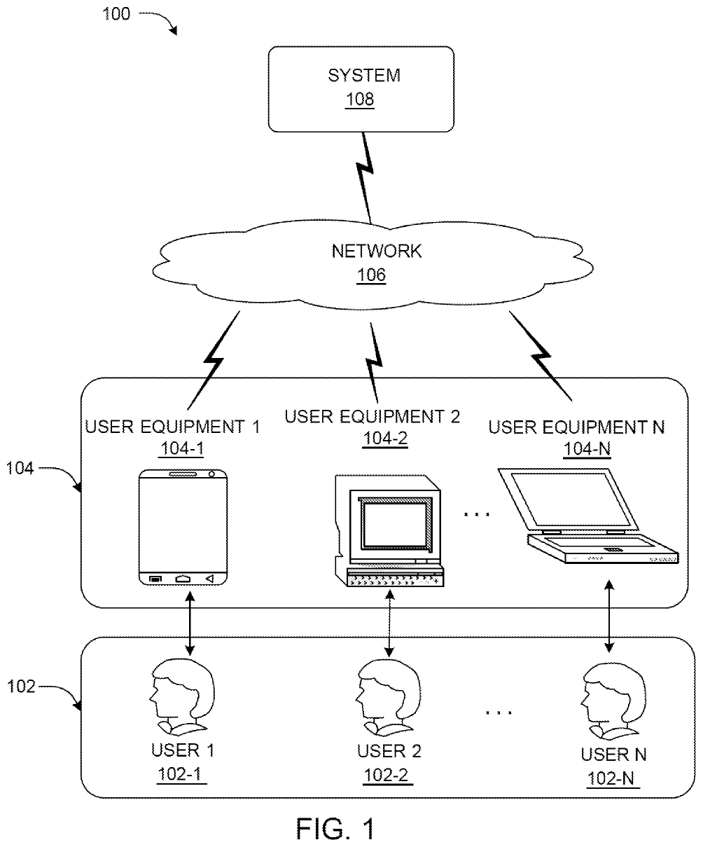

FIG. 1 illustrates an exemplary network architecture (100) in which or with which embodiments of the present disclosure may be implemented.

Referring to FIG. 1, the network architecture (100) may include one or more user equipments (104-1, 104-2 . . . 104-N) associated with one or more users (102-1, 102-2 . . . 102-N) in an environment. A person of ordinary skill in the art will understand that one or more users (102-1, 102-2 . . . 102-N) may be individually referred to as the user (102) and collectively referred to as the users (102). Similarly, a person of ordinary skill in the art will understand that one or more user equipments (104-1, 104-2 . . . 104-N) may be individually referred to as the user equipment (104) and collectively referred to as the user equipment (104). A person of ordinary skill in the art will appreciate that the terms “computing device(s)” and “user equipment” may be used interchangeably throughout the disclosure. Although three user equipments (104) are depicted in FIG. 1, however any number of the user equipments (104) may be included without departing from the scope of the ongoing description.

In an embodiment, the user equipment (104) may include smart devices operating in a smart environment, for example, an Internet of Things (IOT) system. In such an embodiment, the user equipment (104) may include, but is not limited to, smart phones, smart watches, smart sensors (e.g., mechanical, thermal, electrical, magnetic, etc.), networked appliances, networked peripheral devices, networked lighting system, communication devices, networked vehicle accessories, networked vehicular devices, smart accessories, tablets, smart television (TV), computers, smart security system, smart home system, other devices for monitoring or interacting with or for the users (102) and/or entities, or any combination thereof. A person of ordinary skill in the art will appreciate that the user equipment (104) may include, but is not limited to, intelligent, multi-sensing, network-connected devices, that can integrate seamlessly with each other and/or with a central server or a cloud-computing system or any other device that is network-connected.

In an embodiment, the user equipment (104) may include, but is not limited to, a handheld wireless communication device (e.g., a mobile phone, a smart phone, a phablet device, and so on), a wearable computer device (e.g., a head-mounted display computer device, a head-mounted camera device, a wristwatch computer device, and so on), a Global Positioning System (GPS) device, a laptop computer, a tablet computer, or another type of portable computer, a media playing device, a portable gaming system, and/or any other type of computer device with wireless communication capabilities, and the like. In an embodiment, the user equipment (104) may include, but is not limited to, any electrical, electronic, electro-mechanical, or an equipment, or a combination of one or more of the above devices such as virtual reality (VR) devices, augmented reality (AR) devices, laptop, a general-purpose computer, desktop, personal digital assistant, tablet computer, mainframe computer, or any other computing device, wherein the user equipment (104) may include one or more in-built or externally coupled accessories including, but not limited to, a visual aid device such as a camera, an audio aid, a microphone, a keyboard, and input devices for receiving input from the user (102) or the entity such as touch pad, touch enabled screen, electronic pen, and the like. A person of ordinary skill in the art will appreciate that the user equipment (104) may not be restricted to the mentioned devices and various other devices may be used.

Referring to FIG. 1, the user equipment (104) may communicate with a system (108), for example, an Evolved Packet System Fallback (EPSFB) release system, through a network (106). In an embodiment, the network (106) may include at least one of a Fifth Generation (5G) network, or the like. The network (106) may enable the user equipment (104) to communicate with other devices in the network architecture (100) and/or with the system (108). The network (106) may include a wireless card or some other transceiver connection to facilitate this communication. In another embodiment, the network (106) may be implemented as, or include any of a variety of different communication technologies such as a wide area network (WAN), a local area network (LAN), a wireless network, a mobile network, a Virtual Private Network (VPN), the Internet, the Public Switched Telephone Network (PSTN), or the like.

In accordance with embodiments of the present disclosure, the system (108) may be designed and configured for automatically allowing the user to make Voice call on LTE network when the UE is not capable to make Voice call on 5G SA network via redirection or via Handover. Further, the system (108) may allow the user to redirect to LTE RAT on default frequency band configured in gNB during the emergency voice call or when B1 measurement delayed or not received, or while UE is active with other procedure or stuck in race conditions.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

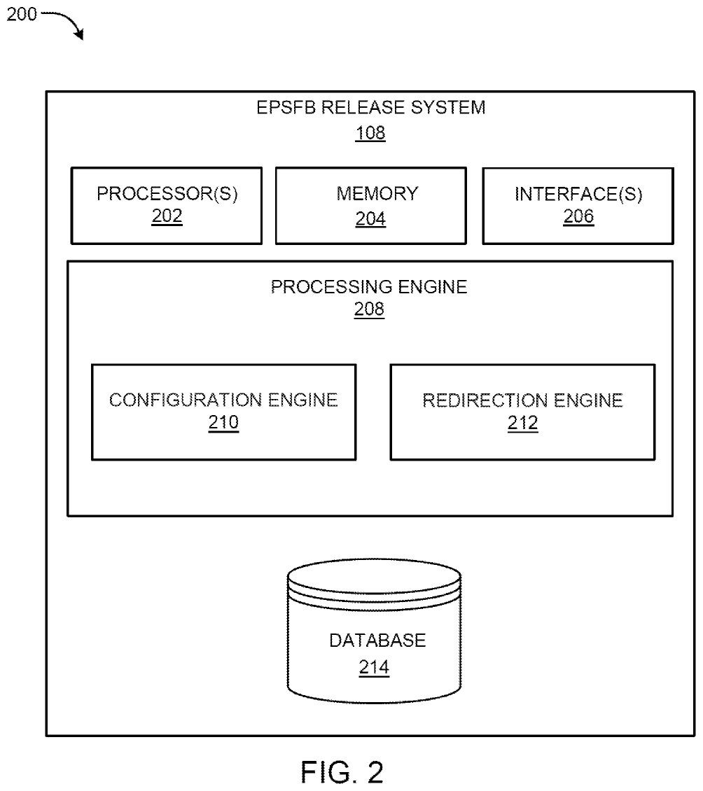

FIG. 2 illustrates an exemplary block diagram (200) of the EPSFB release system (108), in accordance with an embodiment of the present disclosure. It may be appreciated that the system (108) may be similar to the system (108) of FIG. 1 in its functionality.

In an embodiment, and as shown in FIG. 2, the system (108) may include one or more processors (202). The one or more processors (202) may be implemented as one or more microprocessors, microcomputers, microcontrollers, digital signal processors, central processing units, logic circuitries, and/or any devices that manipulate data based on operational instructions. Among other capabilities, the one or more processor(s) (202) may be configured to fetch and execute computer-readable instructions stored in a memory (204) of the system (108). The memory (204) may store one or more computer-readable instructions or routines, which may be fetched and executed to create or share the data units over a network service. The memory (204) may comprise any non-transitory storage device including, for example, volatile memory such as Random-Access Memory (RAM), or non-volatile memory such as Erasable Programmable Read-Only Memory (EPROM), flash memory, and the like.

In an embodiment, the system (108) may also comprise an interface(s) (206). The interface(s) (206) may comprise a variety of interfaces, for example, a variety of interfaces, for example, interfaces for data input and output devices, referred to as I/O devices, storage devices, and the like. The interface(s) (206) may facilitate communication of the system (108) with various devices coupled to it. The interface(s) (206) may also provide a communication pathway for one or more components of the system (108). Examples of such components include, but are not limited to, processing engine(s) (208) and a database (214).

In an embodiment, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor executable instructions stored on a non-transitory machine-readable storage medium and the hardware for the one or more processors (202) may comprise a processing resource (for example, one or more processors), to execute such instructions. In the present examples, the machine-readable storage medium may store instructions that, when executed by the processing resource, implement the processing engine(s) (208). In such examples, the system (108) may comprise the machine-readable storage medium storing the instructions and the processing resource to execute the instructions, or the machine-readable storage medium may be separate but accessible to the system (108) and the processing resource. In other examples, the processing engine(s) (208) may be implemented by electronic circuitry.

In an embodiment, the database (214) may comprise data that may be either stored or generated as a result of functionalities implemented by any of the components of the processor(s) (202) or the processing engine(s) (208) or the system (108). In an exemplary embodiment, the processing engine(s) (208) may include a configuration engine (210), and a redirection engine (212).

In an embodiment, the configuration engine (210) may receive a Packet Data Unit (PDU) session modification request from an Access and Mobility Management Function (AMF) for voice call. The configuration engine (210) may configure the UE with B1 measurement and start process timer to wait for B1Measurement Report (MR) from the UE.

In an embodiment, the redirection engine (212) may make the gNB to redirect the UE to release with redirection on a UE reported LTE frequency band, if a Physical Cell Identifier (PCI) for a target node sent in the MR by the UE does not match with neighbour cells available in a Neighbour Relation Table (NRT).

Although FIG. 2 shows an exemplary block diagram (200) of the EPSFB release system (108), in other embodiments, the EPSFB release system (108) may include fewer components, different components, differently arranged components, or additional functional components than depicted in FIG. 1. Additionally, or alternatively, one or more components of the EPSFB release system (108) may perform functions described as being performed by one or more other components of the EPSFB release system (108).

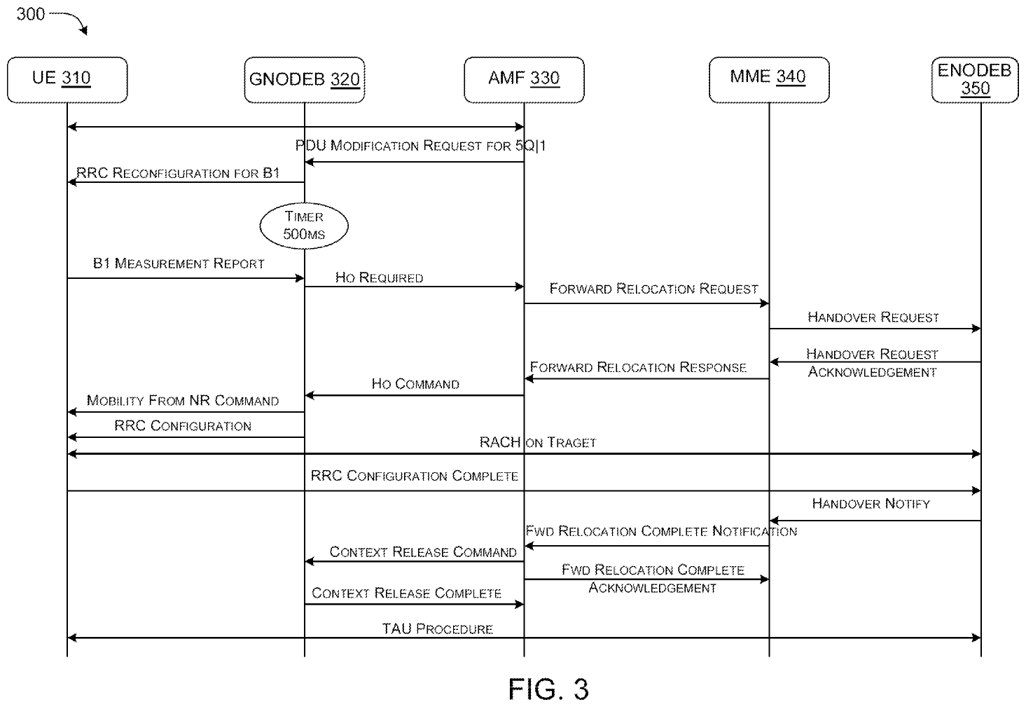

FIG. 3 illustrates an exemplary flow mechanism (300) of 5G to 4G Inter-Radio Access Technology (RAT) handover, in accordance with an embodiment of the present disclosure. With respect to FIG. 3, N26 interface between Access and Mobility Management Function (AMF) (330) and Mobility Management Entity (MME) (340) may use forward relocation procedure, and session management context and user plane tunnels in a core network are exchanged over from Session Management Function/Unified Performance Management (SMF/UPM) to MME/Serving Gateway (S-GW).

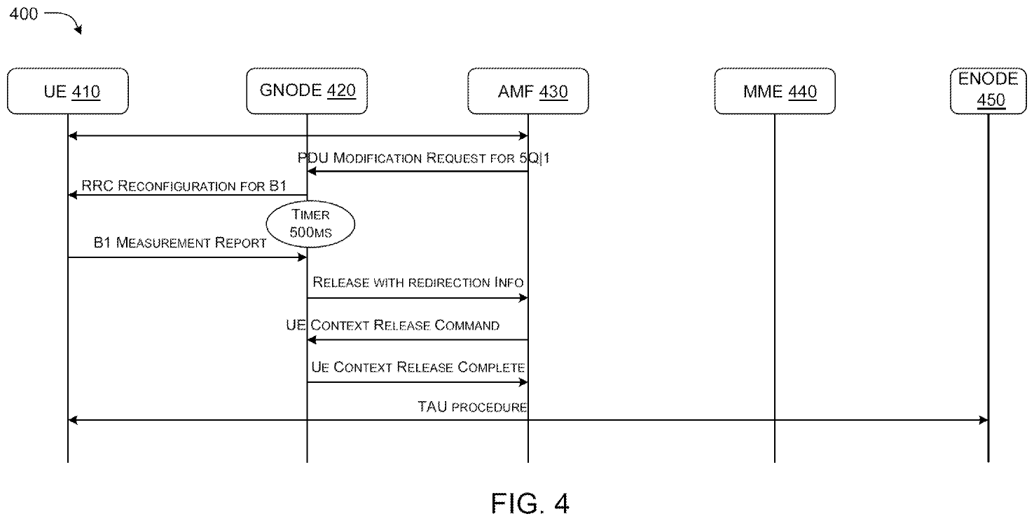

FIG. 4 illustrates an exemplary flow mechanism (400) for performing 5G to 4G release with redirection, in accordance with an embodiment of the present disclosure. With respect to FIG. 4, 5G radio connection may be released with a 5G RRC Release instructing UE (410) to reselect to a 4G cell where a new radio connection may be started for the VOLTE call. In this case the UE context may be transferred from the AMF (430) to the MME (440) over the N26 interface. The choice of method used for EPSFB may depend on UE capability and 5G Core Network Capability.

The EPSFB release system (108) may automatically allow the user to make Voice call on LTE network when UE (410) is not capable to make Voice call on 5G SA network via redirection or via Handover. The EPSFB release system (108) may first prioritize the transition from 5G to 4G during EPSFB via handover, if there is unprecedented failure during the handover procedure it will allow user to release the 5G SA network and redirect to measured Evolved Universal Terrestrial Radio Access (E-UTRA) Absolute Radio Frequency Channel Number (EARFCN) of LTE band to proceed the EPSFB call successfully.

The EPSFB release system (108) may allow the user to redirect to LTE RAT on default frequency band configured in gNB during the emergency voice call or when B1 measurement delayed or not received, or while UE (410) is active with other procedure or stuck in race conditions.

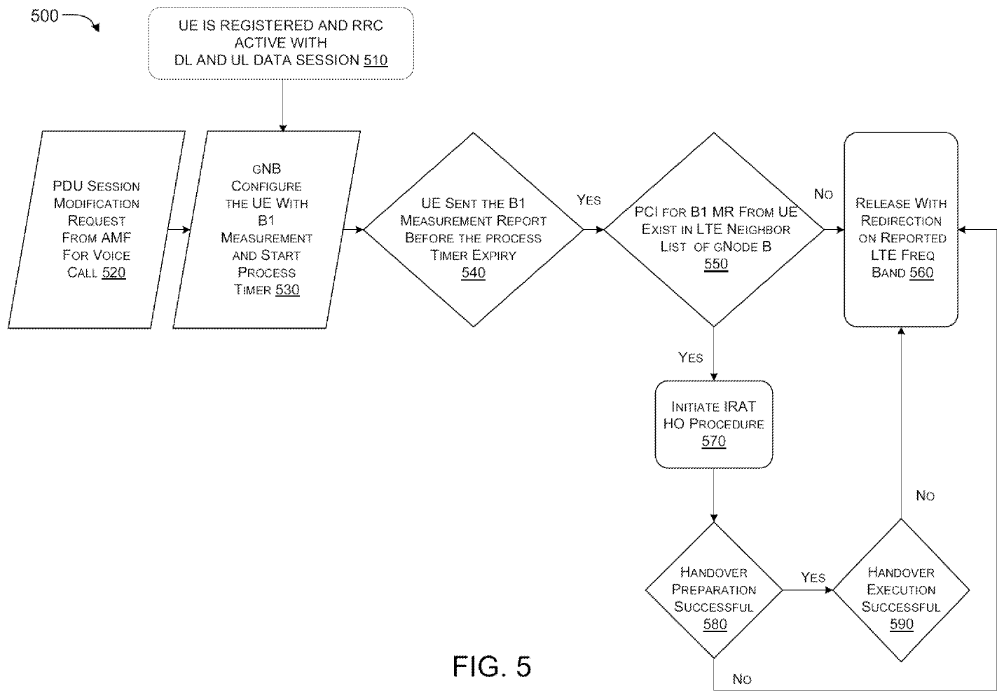

FIG. 5 illustrates an exemplary flow diagram (500) for performing EPSFB release with redirection on reported frequency, in accordance with an embodiment of the present disclosure. With respect to FIG. 5, at 510, UE may be already registered with Radio Resource Control (RRC) active with Downlink (DL) and Uplink (UL) Data Session.

At 520, Packet Data Unit (PDU) session modification request may be received from an Access and Mobility Management Function (AMF) for voice call.

At 530, the gNB may configure the UE with B1 measurement and start a process timer to wait for B1 Measurement Report (MR) from the UE.

At 540, the UE sent the B1 measurement report (MR) before the process timer expiry.

At 550, when the B1 measurement report is received, it is determined if PCI for B1 MR exist in LTE neighbor list of gNodeB.

At 560, the gNB may redirect the UE to release with redirection on UE reported LTE frequency band, if to physical cell identifier (ID) (PCI) for target node sent in the MR by the UE does not match with neighbour calls available in neighbour relation table (NRT).

At 570, when the UE reported target neighbour cells are available in the NRT, the gNB may initiate inter radio access technology (IRAT) handover (HO) procedure.

At 580 and 590, if handover fails (for e.g., network related issue) in preparation phase or in execution Phase, the gNB may redirect the UE to release with redirection on the UE reported LTE frequency band.

In an exemplary embodiment, the present invention discloses a

method for performing an evolved packet system fallback (EPSFB). The method comprising receiving at least one packet data unit (PDU) session modification request related to at least one voice call for at least one user equipment (UE) connected to a source node of a first network. The method comprising configuring the at least one UE with at least one event measurement by the source node. The method comprising receiving at least one measurement report (MR) related to the at least one event measurement from the at least one UE. The at least one MR includes at least one first physical cell identifier (PCI) associated with at least one target node of a second network. The method comprising receiving at least one neighbour relation table (NRT) associated with the at least one UE. The at least one NRT includes at least one second PCI associated with at least one UE reported neighbour cell. The method comprising determining if the first PCI matches with the second PCI. The method comprising redirecting the at least one UE to release a connection with the source node of the first network and reselect at least one UE reported frequency band of the second network when the at least one first PCI do not match with the at least one second PCI. The method comprising initiating a handover procedure when the at least one first PCI matches with the at least one second PCI. The method comprising redirecting the at least one UE to release the connection with the source node of the first network and reselect the at least one UE reported frequency band of the second network when the handover procedure fails.

In some embodiments, the at least one UE is registered with at least one radio resource control (RRC) active mode with a downlink (DL) data session and an uplink (UL) data session.

In some embodiments, the at least one measurement report (MR) is received within an expiry of at least one timer.

In some embodiments, the at least one UE reported frequency band is associated with the at least one UE reported neighbour cell.

In some embodiments, the PDU session modification request is received from an access & mobility management function (AMF) associated with the first network.

In some embodiments, the handover procedure fails due to an issue generated during a preparation phase or an execution phase of the EPSFB. In some embodiments, the at least one MR related to the at least one event measurement received from the at least one UE is a B1 measurement report.

In some embodiments, the initiated handover procedure is an inter radio access technology (IRAT) handover procedure.

In some embodiments, the method further comprising redirecting the at least one UE to release a connection with the source node of the first network and reselect at least one UE reported frequency band of the second network when the B1 measurement report is not received within the expiry of at least one timer.

In some embodiments, the method further comprising redirecting the at least one UE to release a connection with the source node of the first network and reselect at least one UE reported frequency band of the second network when the at least one UE is active with at least one other procedure of the first network.

In some embodiments, the method further comprising redirecting the at least one UE to release a connection with the source node of the first network and reselect at least one UE reported frequency band of the second network when the at least one UE is stuck in at least one race condition generated in the first network.

In some embodiments, the EPSFB is triggered through a handover procedure or a redirection procedure depending upon a plurality of radio frequency (RF) conditions of the at least one UE.

In some embodiments, the plurality of radio frequency (RF) conditions of the at least one UE depends on a geographical area where the at least one UE is located.

In some embodiments, the EPSFB is triggered through a handover procedure or a redirection procedure depending upon the at least one race condition generated in the first network.

In some embodiments, the reported frequency band is configured by a gNodeB during an emergency voice call made by the at least one UE. In some embodiments, the first network is a 5G network and the second network is a 4G network.

In an exemplary embodiment, the present invention discloses a system for performing an evolved packet system fallback (EPSFB). The system is configured to receive at least one packet data unit (PDU) session modification request related to at least one voice call for at least one user equipment (UE) connected to a source node of a first network. The system is configured to configure the at least one UE with at least one event measurement by the source node. The system is configured to receive at least one measurement report (MR) related to the at least one event measurement from the at least one UE. The at least one MR includes at least one first physical cell identifier (PCI) associated with at least one target node of a second network. The system is configured to receive at least one neighbour relation table (NRT) associated with the at least one UE. The at least one NRT includes at least one second PCI associated with at least one UE reported neighbour cell. The system is configured to determine if the first PCI matches with the second PCI. The system is configured to redirect the at least one UE to release a connection with the source node of the first network and reselect at least one UE reported frequency band of the second network when the at least one first PCI do not match with the at least one second PCI. The system is configured to initiate a handover procedure when the at least one first PCI matches with the at least one second PCI. The system is configured to redirect the at least one UE to release the connection with the source node of the first network and reselect the at least one UE reported frequency band of the second network when the at least one handover procedure fails.

In an exemplary embodiment, the present invention discloses a network comprising at least one network element for performing an evolved packet system fallback (EPSFB) release with redirection on at least one reported frequency. The at least one network element is configured to receive at least one packet data unit (PDU) session modification request related to at least one voice call for at least one user equipment (UE) connected to a source node of a first network. The at least one network element is configured to configure the at least one UE with at least one event measurement by the source node. The at least one network element is configured to receive at least one measurement report (MR) related to the at least one event measurement from the at least one UE. The at least one MR includes at least one first physical cell identifier (PCI) associated with at least one target node of a second network. The at least one network element is configured to receive at least one neighbour relation table (NRT) associated with the at least one UE. The at least one NRT includes at least one second PCI associated with at least one UE reported neighbour cell. The at least one network element is configured to determine if the first PCI matches with the second PCI.

The at least one network element is configured to redirect the at least one UE to release a connection with the source node of the first network and reselect at least one UE reported frequency band of the second network when the at least one first PCI do not match with the at least one second PCI. The at least one network element is configured to initiate a handover procedure when the at least one first PCI matches with the at least one second PCI. The at least one network element is configured to redirect the at least one UE to release the connection with the source node of the first network and reselect the at least one UE reported frequency band of the second network when the at least one handover procedure fails.

In an exemplary embodiment, the present invention discloses a user equipment (UE) communicatively coupled with a network. The coupling comprises steps of receiving, by the network, a connection request, sending an acknowledgment of the connection request to the UE and transmitting a plurality of signals in response to the connection request. The network comprising one or more network elements configured to receive at least one packet data unit (PDU) session modification request related to at least one voice call for the UE. The one or more network elements are configured to configure the UE with at least one event measurement, receive at least one measurement report (MR) related to the at least one event measurement from the UE. The at least one MR includes at least one first physical cell identifier (PCI) associated with at least one target node of another network. The one or more network elements are further configured to receive at least one neighbour relation table (NRT) associated with the UE. The at least one NRT includes at least one second PCI associated with the UE reported neighbour cell. The one or more network elements are further configured to determine if the first PCI matches with the second PCI, redirect the UE to release a connection with the network and reselect the UE reported frequency band of another network when the at least one first PCI do not match with the at least one second PCI, initiate a handover procedure when the at least one first PCI matches with the at least one second PCI, and redirect the UE to release the connection with the network and reselect the UE reported frequency band of another network when the handover procedure fails.

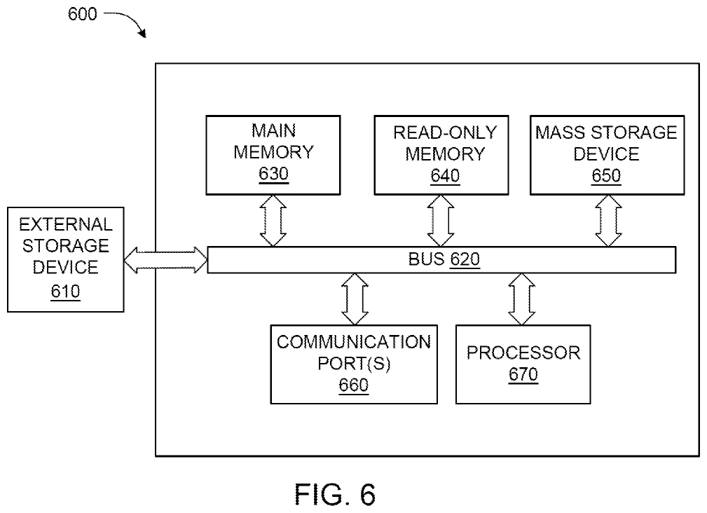

FIG. 6 illustrates an exemplary computer system (600) in which or with which embodiments of the present disclosure may be implemented. As shown in FIG. 6, the computer system (600) may include an external storage device (610), a bus (620), a main memory (630), a read only memory (640), a mass storage device (650), a communication port (660), and a processor (670). A person skilled in the art will appreciate that the computer system (600) may include more than one processor (670) and communication ports (660). Processor (670) may include various modules associated with embodiments of the present disclosure.

In an embodiment, the communication port (660) may be any of an RS-232 port for use with a modem-based dialup connection, a 10/100 Ethernet port, a Gigabit or 10 Gigabit port using copper or fiber, a serial port, a parallel port, or other existing or future ports. The communication port (660) may be chosen depending on a network, such a Local Area Network (LAN), Wide Area Network (WAN), or any network to which computer system connects.

In an embodiment, the memory (630) may be Random Access Memory (RAM), or any other dynamic storage device commonly known in the art. Read-only memory (640) may be any static storage device(s) e.g., but not limited to, a Programmable Read Only Memory (PROM) chips for storing static information e.g., start-up or Basic Input/Output System (BIOS) instructions for the processor (670).

In an embodiment, the mass storage (650) may be any current or

future mass storage solution, which may be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g., an array of disks (e.g., SATA arrays).

In an embodiment, the bus (620) communicatively couples the processor(s) (670) with the other memory, storage and communication blocks. The bus (620) may be, e.g., a Peripheral Component Interconnect (PCI)/PCI Extended (PCI-X) bus, Small Computer System Interface (SCSI), Universal Serial Bus (USB) or the like, for connecting expansion cards, drives and other subsystems as well as other buses, such a front side bus (FSB), which connects the processor (670) to the computer system (600).

Optionally, operator and administrative interfaces, e.g., a display, keyboard, joystick, and a cursor control device, may also be coupled to the bus (620) to support direct operator interaction with the computer system (600). Other operator and administrative interfaces may be provided through network connections connected through the communication port (660). Components described above are meant only to exemplify various possibilities. In no way should the aforementioned exemplary computer system (600) limit the scope of the present disclosure.

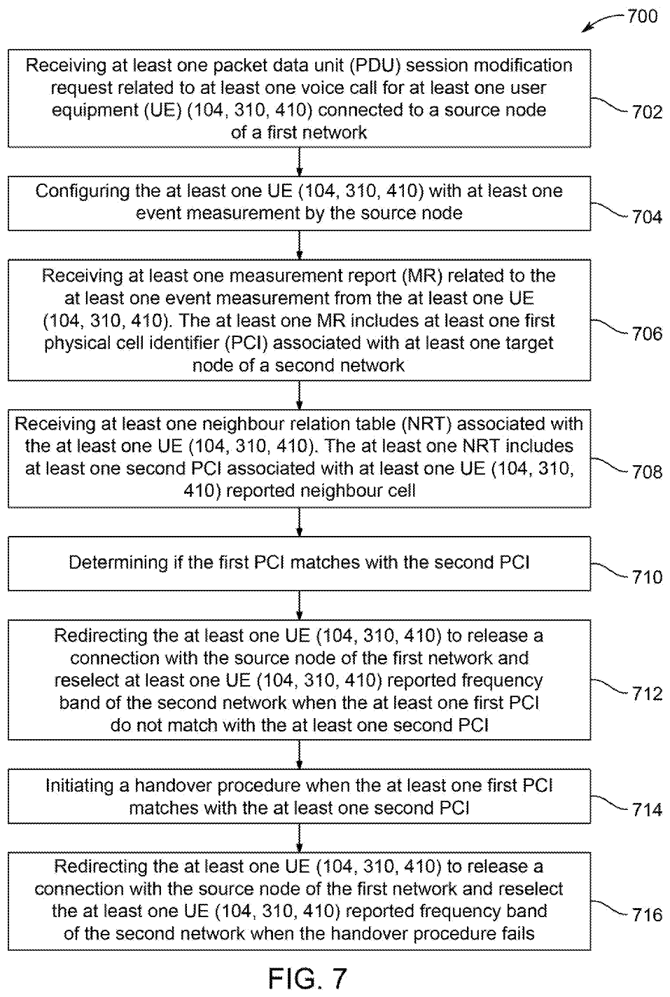

FIG. 7 illustrates an exemplary flow diagram for a method for performing an evolved packet system fallback (EPSFB), in accordance with an embodiment of the present disclosure.

At step 702, the method comprising receiving at least one packet data unit (PDU) session modification request related to at least one voice call for at least one user equipment (UE) (104, 310, 410) connected to a source node of a first network.

At step 704, the method comprising configuring the at least one UE (104, 310, 410) with at least one event measurement by the source node.

At step 706, the method comprising receiving at least one measurement report (MR) related to the at least one event measurement from the at least one UE (104, 310, 410). The at least one MR includes at least one first physical cell identifier (PCI) associated with at least one target node of a second network.

At step 708, the method comprising receiving at least one neighbour relation table (NRT) associated with the at least one UE (104, 310, 410). The at least one NRT includes at least one second PCI associated with at least one UE (104, 310, 410) reported neighbour cell.

At step 710, the method comprising determining if the first PCI matches with the second PCI.

At step 712, the method comprising redirecting the at least one UE (104, 310, 410) to release a connection with the source node of the first network and reselect at least one UE (104, 310, 410) reported frequency band of the second network when the at least one first PCI do not match with the at least one second PCI.

At step 714, the method comprising initiating a handover procedure when the at least one first PCI matches with the at least one second PCI.

At step 716, the method comprising redirecting the at least one UE (104, 310, 410) to release a connection with the source node of the first network and reselect the at least one UE (104, 310, 410) reported frequency band of the second network when the handover procedure fails.

While the foregoing describes various embodiments of the present disclosure, other and further embodiments of the present disclosure may be devised without departing from the basic scope thereof. The scope of the present disclosure is determined by the claims that follow. The present disclosure is not limited to the described embodiments, versions or examples, which are included to enable a person having ordinary skill in the art to make and use the present disclosure when combined with information and knowledge available to the person having ordinary skill in the art.

In an aspect, the present disclosure provides a system, and a method may reduce the delay in Evolved Packet System Fallback (EPSFB) procedure when a gNodeB (gNB) is automatically taking decision to start EPSFB with release with redirection. In an aspect, the present disclosure allows the UE to get redirected on reported frequency with best measurement when handover failed. In an aspect, the present disclosure will reduce the delay in EPSFB procedure when gNB is automatically taking decision to start EPSFB with Release with Redirection. In an aspect, the present disclosure allows the UE to get redirected on reported frequency with best measurement when handover failed. In an aspect, the present disclosure will also improve network KPI of EPS fallback Success rate.

The method described above is well suited for any heterogeneous network with Multi RAT, Multi-vendor consist of different product like Macro, Micro and small cell.

In an aspect, the present disclosure can be implemented within a communication network with multi-RAT, multi-vendor consisting of different product like macro, micro and small cell.

### ADVANTAGES OF THE PRESENT DISCLOSURE

The present disclosure may reduce the delay in Evolved Packet System Fallback (EPSFB) procedure when a gNodeB (gNB) is automatically taking decision to start EPSFB with release with redirection.

The present disclosure may allow the UE to get redirected on reported frequency with best measurement when handover failed.

The present disclosure may be well suited for any heterogeneous network with Multi-Radio Access Technology (RAT), multi-vendor consisting of different product like Macro, Micro and small cell.

The present disclosure may improve network Key Performance Indicators (KPI) of EPSFB success rate.

We claim:

1. A method (700) for performing an evolved packet system fallback (EPSFB), the method comprising:
receiving (702) at least one packet data unit (PDU) session modification request related to at least one voice call for at least one user equipment (UE) (104, 310, 410) connected to a source node of a first network;
configuring (704) the at least one UE (104, 310, 410) with at least one event measurement by the source node;
receiving (706) at least one measurement report (MR) related to the at least one event measurement from the at least one UE (104, 310, 410), wherein the at least one MR includes at least one first physical cell identifier (PCI) associated with at least one target node of a second network;
receiving (708) at least one neighbour relation table (NRT) associated with the at least one UE (104, 310, 410), wherein the at least one NRT includes at least one second PCI associated with at least one UE (104, 310, 410) reported neighbour cell;
determining (710) if the at least one first PCI matches with the at least one second PCI;
redirecting (712) the at least one UE (104, 310, 410) to release a connection with the source node of the first network and reselect at least one UE (104, 310, 410) reported frequency band of the second network when the at least one first PCI do not match with the at least one second PCI;
initiating (714) a handover procedure when the at least one first PCI matches with the at least one second PCI; and
redirecting (716) the at least one UE (104, 310, 410) to release a connection with the source node of the first network and reselect the at least one UE (104, 310, 410) reported frequency band of the second network when the handover procedure fails.

2. The method as claimed in claim 1, wherein the at least one UE (104, 310, 410) is registered with at least one radio resource control (RRC) active mode with a downlink (DL) data session and an uplink (UL) data session.

3. The method as claimed in claim 1, wherein the at least one measurement report (MR) is received within an expiry of at least one timer.

4. The method as claimed in claim 1, wherein the at least one UE (104, 310, 410) reported frequency band is associated with the at least one UE (104, 310, 410) reported neighbour cell.

5. The method as claimed in claim 1, wherein the PDU session modification request is received from an access & mobility management function (AMF) (330, 430) associated with the first network.

6. The method as claimed in claim 1, wherein the handover procedure fails due to an issue generated during a preparation phase or an execution phase of the EPSFB.

7. The method as claimed in claim 1, wherein the at least one MR related to the at least one event measurement received from the at least one UE (104, 310, 410) is a B1 measurement report.

8. The method as claimed in claim 1, wherein the initiated handover procedure is an inter radio access technology (IRAT) handover procedure.

9. The method as claimed in claim 1, further comprising redirecting the at least one UE (104, 310, 410) to release a connection with the source node of the first network and reselect at least one UE (104, 310, 410) reported frequency band of the second network when the B1 measurement report is not received within the expiry of at least one timer.

10. The method as claimed in claim 1, further comprising redirecting the at least one UE (104, 310, 410) to release a connection with the source node of the first network and reselect at least one UE (104, 310, 410) reported frequency band of the second network when the at least one UE (104, 310, 410) is active with at least one other procedure of the first network.

11. The method as claimed in claim 1, further comprising redirecting the at least one UE (104, 310, 410) to release a connection with the source node of the first network and reselect at least one UE (104, 310, 410) reported frequency band of the second network when the at least one UE (104, 310, 410) is stuck in at least one race condition generated in the first network.

12. The method as claimed in claim 1, wherein the EPSFB is triggered through the handover procedure or theredirection procedure based upon a plurality of radio frequency (RF) conditions of the at least one UE (104, 310, 410).

13. The method as claimed in claim 1, wherein the plurality of radio frequency (RF) conditions of the at least one UE (104, 310, 410) depends on a geographical area where the at least one UE (104, 310, 410) is located.

14. The method as claimed in claim 1, wherein the EPSFB is triggered through the handover procedure or the redirection procedure depending upon the at least one race condition generated in the first network.

15. The method as claimed in claim 1, wherein the reported frequency band is configured by a gNodeB during an emergency voice call made by the at least one UE (104, 310, 410).

16. The method as claimed in claim 1, wherein the first network is a 5G network and the second network is a 4G network.

17. A system for performing an evolved packet system fallback (EPSFB), the system is configured to:
receive, by a configuration engine (210), at least one packet data unit (PDU) session modification request related to at least one voice call for at least one user equipment (UE) (104, 310, 410) connected to a source node of a first network;
configure, by the configuration engine (210), the at least one UE (104, 310, 410) with at least one event measurement by the source node;
receive at least one measurement report (MR) related to the at least one event measurement from the at least one UE (104, 310, 410), wherein the at least one MR includes at least one first physical cell identifier (PCI) associated with at least one target node of a second network;
receive at least one neighbour relation table (NRT) associated with the at least one UE (104, 310, 410), wherein the at least one NRT includes at least one second PCI associated with at least one UE (104, 310, 410) reported neighbour cell;
determine if the at least one first PCI matches with the at least one second PCI;
redirect, by a redirection engine (212), the at least one UE (104, 310, 410) to release a connection with the source node of the first network and reselect at least one UE (104, 310, 410) reported frequency band of the second network when the at least one first PCI do not match with the at least one second PCI;
initiate a handover procedure when the at least one first PCI matches with the at least one second PCI; and
redirect, by the redirection engine (212), the at least one UE (104, 310, 410) to release the connection with the source node of the first network and reselect the at least one UE (104, 310, 410) reported frequency band of the second network when the handover procedure fails.

18. The system as claimed in claim 17, wherein the at least one UE (104, 310, 410) is registered with at least one radio resource control (RRC) active mode with a downlink (DL) data session and an uplink (UL) data session.

19. The system as claimed in claim 17, wherein the at least one measurement report (MR) is received within an expiry of at least one timer.

20. The system as claimed in claim 17, wherein the at least one UE (104, 310, 410) reported frequency band is associated with the at least one UE (104, 310, 410) reported neighbour cell.

21. The system as claimed in claim 17, wherein the PDU session modification request is received from an access and mobility management function (AMF) (330, 430) associated with the first network.

22. The system as claimed in claim 17, wherein the handover procedure fails due to an issue generated during a preparation phase or an execution phase of the EPSFB.

23. The system as claimed in claim 17, wherein the at least one MR related to the at least one event measurement received from the at least one UE (104, 310, 410) is a B1 measurement report.

24. The system as claimed in claim 17, wherein the initiated handover procedure is an inter radio access technology (IRAT) handover procedure.

25. The system as claimed in claim 17, further configured to redirect the at least one UE (104, 310, 410) to release a connection with the source node of the first network and reselect at least one UE (104, 310, 410) reported frequency band of the second network when the B1 measurement report is not received within the expiry of at least one timer.

26. The system as claimed in claim 17, further configured to redirect the at least one UE (104, 310, 410) to release a connection with the source node of the first network and reselect at least one UE (104, 310, 410) reported frequency band of the second network when the at least one UE (104, 310, 410) is active with at least one other procedure of the first network.

27. The system as claimed in claim 17, further configured to redirect the at least one UE (104, 310, 410) to release a connection with the source node of the first network and reselect at least one UE (104, 310, 410) reported frequency band of the second network when the at least one UE (104, 310, 410) is stuck in at least one race condition generated in the first network.

28. The system as claimed in claim 17, wherein the EPSFB is triggered through a handover procedure or a redirection procedure depending upon a plurality of radio frequency (RF) conditions of the at least one UE (104, 310, 410).

29. The system as claimed in claim 17, wherein the plurality of radio frequency (RF) conditions of the at least one UE (104, 310, 410) depends on a geographical area where the at least one UE (104, 310, 410) is located.

30. The system as claimed in claim 17, wherein the EPSFB is triggered through a handover procedure or a redirection procedure depending upon the at least one race condition generated in the first network.

31. The system as claimed in claim 17, wherein the reported frequency band is configured by a gNodeB during an emergency voice call made by the at least one UE (104, 310, 410).

32. The system as claimed in claim 17, wherein the first network is a 5G network and the second network is a 4G network.

33. A network comprising one or more network elements for performing an evolved packet system fallback (EPSFB) release with redirection on at least one reported frequency, the one or more network elements configured to:
receive, by a configuration engine (210), at least one packet data unit (PDU) session modification request related to at least one voice call for at least one user equipment (UE) (104, 310, 410) connected to a source node of the network;
configure, by the configuration engine (210), the at least one UE (104, 310, 410) with at least one event measurement by the source node;
receive at least one measurement report (MR) related to the at least one event measurement from the at least one UE (104, 310, 410), wherein the at least one MR includes at least one first physical cell identifier (PCI) associated with at least one target node of another network;
receive at least one neighbour relation table (NRT) associated with the at least one UE (104, 310, 410), wherein the at least one NRT includes at least one second PCI associated with at least one UE (104, 310, 410) reported neighbour cell;
determine if the first PCI matches with the second PCI;
redirect, by a redirection engine (212), the at least one UE (104, 310, 410) to release a connection with the source node of the network and reselect at least one UE (104, 310, 410) reported frequency band of another network when the at least one first PCI do not match with the at least one second PCI;
initiate a handover procedure when the at least one first PCI matches with the at least one second PCI; and
redirect, by the redirection engine (212), the at least one UE (104, 310, 410) to release the connection with the source node of the network and reselect the at least one UE (104, 310, 410) reported frequency band of another network when the handover procedure fails.

34. A computer program product comprising a non-transitory computer-readable medium comprising instructions that, when executed by one or more processors, cause the one or more processors to perform a method for performing an evolved packet system fallback (EPSFB), the method comprising:
receiving, by a configuration engine (210), at least one packet data unit (PDU) session modification request related to at least one voice call for at least one user equipment (UE) (104, 310, 410) connected to a source node of a first network;
configuring, by the configuration engine (210), the at least one UE (104, 310, 410) with at least one event measurement by the source node;
receiving at least one measurement report (MR) related to the at least one event measurement from the at least one UE (104, 310, 410), wherein the at least one MR includes at least one first physical cell identifier (PCI) associated with at least one target node of a second network;
receiving at least one neighbour relation table (NRT) associated with the at least one UE (104, 310, 410), wherein the at least one NRT includes the at least one second PCI associated with at least one UE (104, 310, 410) reported neighbour cell;
determining if the first PCI matches with the second PCI;
redirecting, by a redirection engine (212), the at least one UE (104, 310, 410) to release a connection with the source node of the first network and reselect at least one UE (104, 310, 410) reported frequency band of the second network when the at least one first PCI do not match with the at least one second PCI;
initiating a handover procedure when the at least one first PCI matches with the at least one second PCI; and
redirecting, by the redirection engine (212), the at least one UE (104, 310, 410) to release the connection with the source node of the first network and reselect the at least one UE (104, 310, 410) reported frequency band of the second network when the handover procedure fails.

35. A user equipment (UE) (104, 310, 410) communicatively coupled with a network, the coupling comprises steps of:
receiving, by the network, a connection request;
sending an acknowledgment of the connection request to the UE (104, 310, 410); and
transmitting a plurality of signals in response to the connection request, wherein the network comprising the one or more network elements configured for:
receiving at least one packet data unit (PDU) session modification request related to at least one voice call for the UE (104, 310, 410);
configuring the UE (104, 310, 410) with at least one event measurement;
receiving at least one measurement report (MR) related to the at least one event measurement from the UE (104, 310, 410), wherein the at least one MR includes at least one first physical cell identifier (PCI) associated with at least one target node of another network;
receiving at least one neighbour relation table (NRT) associated with the UE (104, 310, 410), wherein the at least one NRT includes at least one second PCI associated with the UE (104, 310, 410) reported neighbour cell;
determining whether the at least one first PCI matches with the at least one second PCI;
redirecting the UE (104, 310, 410) to release a connection with the network and reselect the UE (104, 310, 410) reported frequency band of another network when the at least one first PCI does not match with the at least one second PCI;
initiating a handover procedure when the at least one first PCI matches with the at least one second PCI; and
redirecting the UE (104, 310, 410) to release the connection with the network and reselect the UE (104, 310, 410) reported frequency band of another network when the handover procedure fails.
